(19) United States
(12) Patent Application Publication
(10) Pub. No.: US 2007/0123098 A1
(43) Pub. Date: May 31, 2007

(54) Screwless wall-plate

(76) Inventor: Huadao Huang, Shanghai (CN)

Correspondence Address: ANDREWS KURTH LLP;Intellectual Property Department, Suite 1100, 1350 I Street N.W., Washington, DC, 20005, US

(21) Appl. No.: 11/540,587

(22) Filed: Oct. 2, 2006

(30) Foreign Application Priority Data
Nov. 28, 2005 (CN) 200520142027.0

(51) Int. Cl. H01R 13/60

(52) U.S. Cl. 439/535

(57) ABSTRACT

The present invention provides a wall plate assembly which contains a wall plate having at least an opening which is adapted to receive a wiring device. The wall plate assembly is characterized by its not requiring a screw to connect the wall plate to the wiring device, which is accomplished by having a set of a plurality of recesses on at least a rack located at the backside of the wall plate to be engaged with a set of a plurality of protrusions located at the corresponding side of the wiring device, thereby, by applying a gentle force and due to the engagement between the recesses and protrusions, the wall plate is securely connected to the wiring device. The wall plate further contains a groove at the outside rim of the wall plate, thereby, by inserting a pointed instrument into the groove, the wall plate can be easily detached from the wiring device.

### FIELD OF THE INVENTION

The present invention provides a wall plate assembly which contains a wall plate having at least an opening which is adapted to receive a wiring device, such as an outlet, a switch, or a ground fault circuit interrupter (“GFCI”). The wall plate assembly is characterized by its requiring no screw to connect the wall plate to the wiring device, which is accomplished by having a set of a plurality of recesses on at least a rack located at the backside of the wall plate to be engaged with a set of a plurality of protrusions located at the corresponding side of the wiring device, thereby, by applying a gentle force and due to the engagement between the recesses and protrusions, the wall plate is securely connected to the wiring device. The wall plate further contains a groove at the outer rim of the wall plate, thereby, by inserting a pointed instrument into the groove, the wall plate can be easily detached from the wiring device.

### BACKGROUND OF THE INVENTION

With the rapid advancement of technology, consumers have placed higher demands on basic consumer products. Consumers want products that have a pleasing appearance, are easy to use, and can be installed in user friendly manner. With respect to household interrupters and switches, consumers increasingly demand products that are easy to remove and/or reassemble during repairs.

As shown in FIG. 1, a prior art wall-plate assembly for mounting a wiring device, such as a ground fault circuit interrupter (“GFCI”), with a wall plate to the wall typically includes a wall plate 1, a wiring device 2, and an installation box 3. Installation holes 11, 21 are arranged, respectively, on the wall pate 1 and the wiring device 2. Screw holes 22, 31 are arranged, respectively, on the wiring device 2 and the installation box 3.

During installation, the installation box 3 is first installed inside the wall. Next, the wiring device 2 is inserted into the installation box 3. One or more screws 4 are threaded through the corresponding installation holes 21 on the wiring device 2 and then threaded into the corresponding screw holes 31 on the installation box 3, thus securing the wiring device 2 inside the installation box 3. Finally, one or more screws 5 are threaded through the corresponding installation holes 11 on the wall plate 1 and then threaded into the corresponding screw hole 22 on the wiring device 2, thus securing the wall plate 1 onto the wiring device 2.

Also as shown in FIG. 1 (prior art), the wall plate 1 of the wall-plate assembly is fastened onto the wiring device 2 through multiple screws 5. There are several problems associated with this design. Since screws are made of metal, their spray painted surface wears off easily and can develop rust, thus adversely affecting the appearance of the wall plate 1. Similarly, exposing the metal screws 5 outside of the wall plate 1 compromises the pleasing effect of the wall plate. Additionally, it is not easy to install and remove the wall plate 1 because a screwdriver is required to manage the screws. Furthermore, it is easy to misplace or lose the tiny screws during installation and disassembly.

It is therefore the objective of the present invention to design a wall plate assembly which requires no screw to securely connect the wall plate to a wiring device.

### SUMMARY OF THE INVENTION

The present invention provides a wall plate which contains at least an opening, which is adapted to receive a wiring device. The wall plate has at least a rack containing a set of a plurality of recesses located at a back side of the wall plate. The wiring device contains at least a set of a plurality of protrusions at a corresponding location to the plurality of recesses. The set of the plurality of protrusions on the wiring device is adapted to engage with the set of the plurality of recesses on the rack of the wall plate to securely connect the wiring device to the wall plate. The wall plate is characterized by its capability of not requiring the use of a screw to connect the wiring device to the wall plate. The recesses and protrusions are preferably shaped as matching teeth or gears.

The preferred embodiment of the wall plate contains two racks located above the opening of said wall plate and two racks located below the opening of the wall plate. In this embodiment, the wiring device also contains two sets of the plurality of protrusions located at the upper side of the wiring plate corresponding to the two racks located above the opening of the wall plate and two sets of the plurality of protrusions located at the lower side of the wiring device corresponding to the two racks located below the opening of the wall plate. Each of the sets of the plurality of protrusions on the wiring device is engaged with each of the sets of the plurality of recesses on the wall plate to securely connect the wiring device to the wall plate.

Preferably, the wall plate comprises at least a groove which is located at an outer rim of the wall plate to facilitate the disassembly of the wall plate from the wiring device.

The wall plate is further characterized by not having an installation hole.

The wiring device is preferably an outlet, a switch, or a ground fault circuit interrupter.

The present invention also provides a wall plate assembly which comprises a wall plate having at least an opening which can receive a wiring device, and a wiring device which is adapted to fit into the opening of the wall plate. The wall plate contains at least a rack containing a plurality of recesses on the backside of the wall plate. The plurality of recesses on the rack is adapted to connect to the set of protrusions on the corresponding side of the wiring device. The set of the plurality of protrusions is adapted to engage with the set of the plurality of recesses on the rack to securely connect the wiring device to the wall plate. The wall plate assembly does not require a screw to connect the wiring device to the wall plate.

The wall plate further comprises a groove at the outer rim of the wall plate to facilitate the detachment of the wall plate from the wiring device. The wiring device is an outlet, a switch, or a ground fault circuit interrupter.

The present invention further provides a method for installing the wall plate assembly which comprises: inserting an installation box inside a wall; fastening the wiring device to the installation box; engaging the set of the plurality of recesses on the rack of the wall plate with the set of the plurality of the protrusions on the wiring device; and applying a gentle force to the wall plate against the wiring device to securely connect the wall plate to the wiring device, so that the recesses on the rack of the wall plate are securely locked into the protrusions on the wiring device.

The fastener that can be used to fasten the wiring device to the installation box includes, but is not limited to, a screw, a clasp, a tie, a snap, a pin, a clip, a toggle, a hook and eye, a buckle, a button, a press-stud, or a closure.

Finally, the present invention provides a method to detach the wall plate from the wiring device by inserting a pointed instrument into the groove of the wall plate; and applying a gentle force to pry open and detach the wall plate from the wiring device by causing the recesses on the rack of the wall plate to disengage with the corresponding protrusions on the wiring device. The pointed instrument used to pry open the wall plate can be a tip of a screwdriver.

### BRIEF DESCRIPTION OF THE DRAWINGS

The detailed description will refer to the following drawings in which like numerals refer to like elements, and in which:

FIG. 1 illustrates a prior art wall plate assembly, where the wall plate is fastened to the wiring device by screws.

FIG. 2 illustrates an exemplary wall plate assembly.

FIG. 3 is a partial cross-sectional side view of the wall-plate assembly of FIG. 2 with a wall plate shown in stripe.

FIG. 4 is an enlarged view illustrating the engagement between the recesses on the rack of the wall plate and the protrusions on the side of the wiring device as shown in part A of FIG. 3.

### DETAILED DESCRIPTION OF THE INVENTION

The present invention offers an exemplary wall plate which is particularly characterized by its smooth, flat, and aesthetically appealing appearance. The wall plate is connected to a wiring device to form a wall plate assembly. The wall plate assembly is further advantageous by its characteristics of being able to easily and quickly install and remove. Additionally, the wall plate assembly of the present invention has the advantages of not requiring a screw to securely connect the wall plate to the wiring device by using a recesses-protrusions engagement principle. The wiring device is preferably an outlet, a switch, or a ground fault circuit interrupter.

The following designs are illustrative, but not limiting the scope of the present invention. Reasonable variations, such as those occur to reasonable artisan, can be made herein without departing from the scope of the present invention.

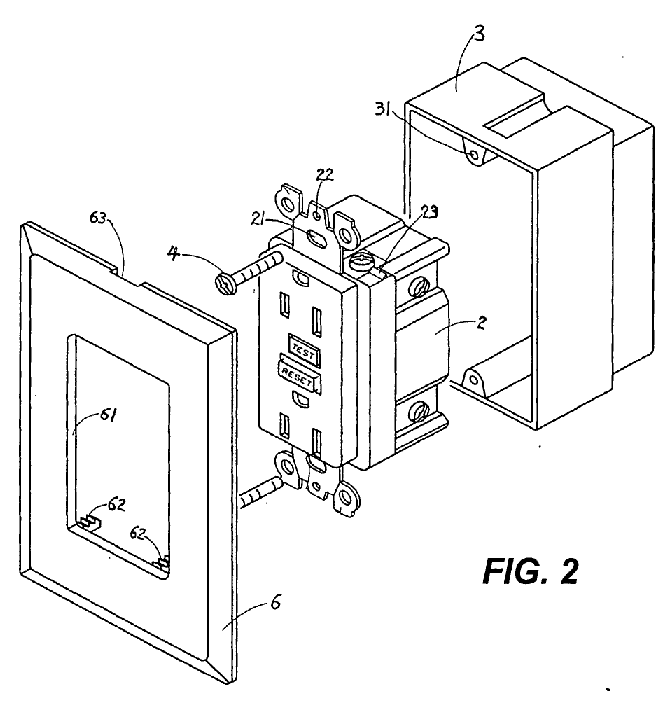

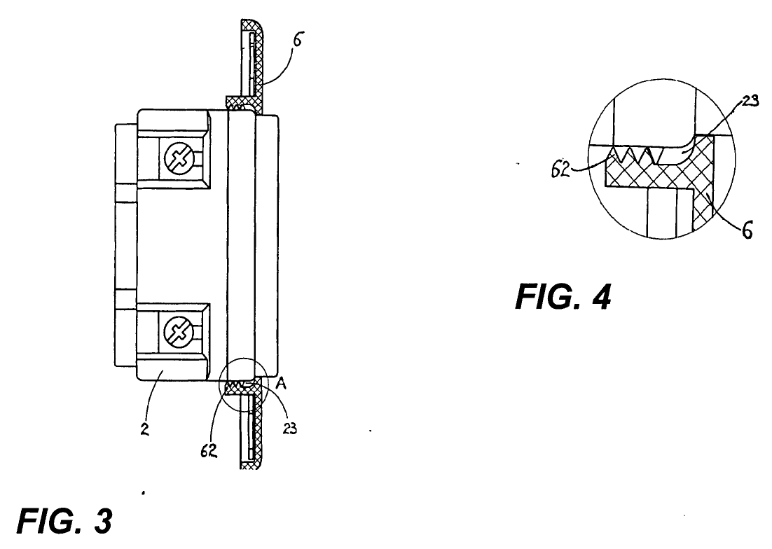

FIG. 2 illustrates an exemplary wall plate assembly. FIG. 3 is a partial cross-sectional side view of the exemplary wall plate assembly of FIG. 2. FIG. 4 is an enlarged view illustrating the engagement of the recesses-protrusions as shown in part A of FIG. 3.

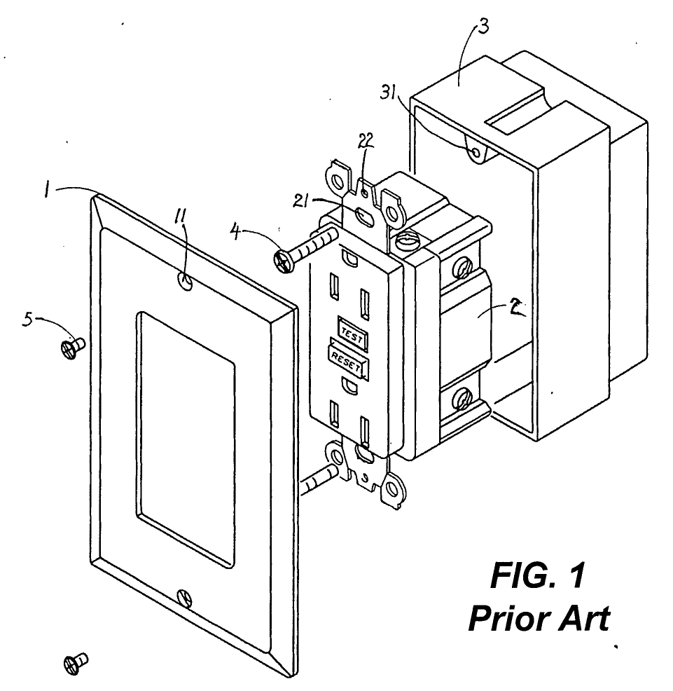

As shown in FIGS. 2-4, an exemplary wall plate assembly includes a wall plate 6, a wiring device 7, and an installation box 3. The installation box 3 may be the same as that shown in FIG. 1.

The wall plate 6 has no installation holes on its surface, thus offering a smooth and flat surface. An opening 61 is arranged near the center of the wall plate 6 to expose the wiring device 7. The wall plate 6 includes several racks 62 with teeth-like or gear-like recesses on the backside of the wall plate 6 which allow the wall plate 6 to securely connect to the wiring device 7.

The wiring device 7 includes several protrusions 23 capable of engaging with the teeth-like or gear-like recesses on the racks 62 at locations corresponding to the racks 62 on the backside of the wall plate 6. For example, as shown in FIG. 2, several protrusions 23 are arranged on the upper and lower parts of the wiring device 7 to correspond to the recesses of the racks 62 on the backside of the wall plate 6.

In one embodiment, four racks 62 with recesses are arranged on the backside of the wall plate 6, two above and two below the central opening 61, corresponding to four sets of protrusions 23 arranged on the wiring device 7. One skilled in the art will appreciate that racks with recesses can be placed at different locations on the backside of the wall plate 6, including the upper, lower, left, and right sides of the wall plate 6.

During installation, the installation box 3 is first inserted into the utility hole on the wall. Next, the wiring device 7 is securely inserted into and fastened to the installation box 3 by a fastener, such as using one or more screws 4. Other fastener includes, but is not limited to, clasps, ties, snaps, pins, clips, toggles, hooks and eyes, buckles, buttons, press-studs, or closures.

The screws 4 are threaded through the corresponding installation holes 21 on the wiring device 7 and then threaded into the corresponding screw holes 31 on the installation box 3, securing the wiring device 2 to the installation box 3.

Finally, the wall plate 6 is connected to the wiring device by engaging the recesses on the racks 62 located on the backside of the wall plate 6 with the corresponding protrusions 23 located on the wiring device 7 with a gentle upward push. Installation of the wall plate 6 is easy and quick, using the principle of teeth or gear engagement.

The wall plate 6 can be removed from the wiring device 7 quickly. As shown in FIG. 2, a groove 63 is arranged on one side of the wall plate 6 for easy and quick removal. The groove 63 is shown in FIG. 2 as located on an upper side of the wall plate 6. One skilled in the art will appreciate that the groove 63 may be located at other locations on the wall plate 6.

When the wall plate 6 needs to be removed, a user simply inserts the tip of a pointed instrument, such as a flathead screwdriver, into the groove 63 to gently pry open the wall plate 6. The recesses on the racks 62 on the backside of the wall plate 6 will rise above the corresponding protrusions 23 and disengage from the protrusions 23 on the wiring device 7. The wall plate 6 can then be easily separated from the wiring device 7.

While the wall plate assembly has been described in connection with an exemplary embodiment, those skilled in the art will understand that many modifications in light of these teachings are possible, and this application is intended to cover variations thereof. Therefore, the scope of the appended claims should be accorded the broadest interpretation so as to encompass all such modifications.

1. A wall plate comprising:
at least an opening, which is adapted to receive a wiring device;
said wall plate comprising at least a rack containing a set of a plurality of recesses on a back side of said wall plate;
wherein said wiring device comprises at least a set of a plurality of protrusions which is fixed on an outer edge on said wiring device at a corresponding location to said plurality of recesses on said back side of said wall plate;
wherein said set of said plurality of protrusions is adapted to engage with said set of plurality of recesses on said rack to securely connect said wiring device to said wall plate;
wherein said wall plate does not require a screw to connect said wiring device to said wall plate.

2. The wall plate according to claim 1, wherein said wall pate contains two of said rack located above said opening of said wall plate, and two of said rack located below said opening of said wall plate;
wherein said wiring device contains two sets of said plurality of protrusions located at an upper side of said wiring plate corresponding to said two of said rack located above said opening of said wall plate and two sets of said plurality of protrusions located at a lower side of said wiring device corresponding to said two of said rack located below said opening of said wall plate;
wherein each of said sets of said plurality of protrusions on said wiring device is engaged with each of said sets of said plurality of recesses on said wall plate to securely connect said wiring device to said wall plate.

3. The wall plate according to claim 1, further comprising at least a groove located on an outer rim of said wall plate to facilitate disassembly of said wall plate from said wiring device.

4. The wall plate according to claim 1, wherein said wall plate does not have an installation hole.

5. The wall plate according to claim 1, wherein said wiring device is a ground fault circuit interrupter.

6. The wall plate according to claim 1, wherein said recesses and said protrusions are shaped as matching teeth or gears.

7. A wall plate assembly comprising:
a wall plate having at least an opening which is adapted to receive a wiring device and a wiring device which is adapted to fit into said opening of said wall plate;
wherein said wall plate contains at least a rack containing a plurality of recesses on a backside of said wall plate; wherein said plurality of recesses on said rack is adapted to connect to a set of protrusions on a corresponding side of which is fixed on an outer edge of said wiring device;
wherein said set of said plurality of protrusions on said outer edge of said wiring device is adapted to engage with said set of said plurality of recesses on said rack to securely connect said wiring device to said wall plate; and
wherein said wall plate assembly does not require a screw to connect said wiring device to said wall plate.

8. The wall plate assembly according to claim 7, wherein said wall plate comprises a groove at an outer rim of said wall plate to facilitate detachment of said wall plate from said wiring device.

9. The wall plate assembly according to claim 7, wherein said wiring device is a ground fault circuit interrupter.

10. A method for installing said wall plate assembly according to claim 7 comprising:
inserting an installation box inside a wall;
fastening said wiring device to said installation box with a fastener;
engaging said set of said plurality of recesses on said rack of said wall plate with said set of said plurality of said protrusions on said edge of said wiring device; and
applying a gentle force to said wall plate against said wiring device to securely connect said wall plate to said wiring device.

11. The method according to claim 10, wherein said set of said plurality of recesses on said rack of said wall plate is securely locked into said set of said plurality of protrusions on said wiring device.

12. The method according to claim 10, wherein said fastener for fastening said wiring device to said installation box is at least one selected from the group consisting of a screw, a clasp, a tie, a snap, a pin, a clip, a toggle, a hook and eye, a buckle, a button, a press-stud, and a closure.

13. A method for detaching said wall plate from said wall plate assembly according of claim 8 comprising:
inserting a pointed instrument into said groove of said wall plate; and
applying a gentle force to pry open and detach said wall plate from said wiring device.

14. The method according to claim 13, wherein said prying open step includes causing said set of said plurality of recesses on said rack of said wall plate to disengage with said corresponding set of said plurality of protrusions on said wiring device.

15. The method according to claim 13, wherein said pointed instrument is a tip of a screwdriver.
